(19) United States
(12) Patent Application Publication
(10) Pub. No.: US 2011/0267262 A1
(43) Pub. Date: Nov. 3, 2011

(54) Laser Scanning Projector Device for Interactive Screen Applications

(76) Inventor: Jacques Gollier, Painted Post, NY (US)

(21) Appl. No.: 13/094,086

(22) Filed: Apr. 26, 2011

Related U.S. Application Data
(60) Provisional application No. 61/329,811, filed on Apr. 30, 2010.

(51) Int. Cl. G06F 3/01

(52) U.S. Cl. 345/156

(57) ABSTRACT

One embodiment of the device comprising: (i) a laser scanning projector that projects light on a diffusing surface illuminated by the scanning projector; (ii) at least one detector that detects, as a function of time, the light scattered by the diffusing surface and by at least one object entering area illuminated by the scanning projector; and (iii) an electronic device capable of (a) reconstructing, from the detector signal, an image of the object and of the diffusing surface and (b) determining variation of the distance between the object and the diffusing surface

This application claims the priority of U.S. Provisional Application Ser. No. 61/329,811 filed Apr. 30, 2010.

### BACKGROUND

1. Field of the Invention

The present invention relates generally to laser scanning projectors and devices utilizing such projectors, and more particularly to devices which may be used in interactive or touch screen applications.

2. Technical Background

Laser scanning projectors are currently being developed for embedded micro-projector applications. That type of projector typically includes 3 color lasers (RGB) and one or two fast scanning mirrors for scanning the light beams provided by the lasers across a diffusing surface, such as a screen. The lasers are current modulated to create an image by providing different beam intensities.

Bar code reading devices utilize laser scanners for scanning and reading bar code pattern images. The images are generated by using a laser to provide a beam of light that is scanned by the scanning mirror to illuminate the bar code and by using a photo detector to collect the light that is scattered by the illuminated barcode.

Projectors that can do some interactive functions typically utilize a laser scanner, usually require at least one array of CCD detectors, and at least one imaging lens. These components are bulky and therefore this technology can not be used in embedded applications in small devices, such as cell phones, for example.

No admission is made that any reference described or cited herein constitutes prior art. Applicant expressly reserves the right to challenge the accuracy and pertinency of any cited documents.

### SUMMARY

One or more embodiments of the disclosure relate to a device including: (i) a laser scanning projector that projects light onto a diffusing surface illuminated by the laser scanning scanning projector; (ii) at least one detector that detects, as a function of time, the light scattered by the diffusing surface and by at least one object entering the area illuminated by the scanning projector; and (iii) an electronic device) capable of: (a) reconstructing, from the detector signal, an image of the object and of the diffusing surface and (b) determining the location of the object relative to the diffusing surface.

According to some embodiments the device includes: (i) a laser scanning projector that projects light onto a diffusing surface illuminated by the laser scanning scanning projector; (ii) at least one detector that detects, as a function of time, the light scattered by the diffusing surface and by at least one object entering the area illuminated by the scanning projector; and (iii) an electronic device capable of: (a) reconstructing, from the detector signal, an image of the object and of the diffusing surface and (b) determining the distance D and/or variation of the distance D between the object and the diffusing surface between the object and the diffusing surface. According to at least some embodiments the electronic device, in combination with said detector, is also capable of determining the X-Y position of the object on the diffusing surface.

In at least one embodiment, the scanning projector and the detector are displaced with respect to one another in such a way that the illumination angle from the projector is different from the light collection angle of the detector; and the electronic device is capable of: (i) reconstructing from the detector signal a 2D image of the object and of the diffusing surface; and (ii) sensing the width W of the imaged object to determine the distance D, and/or variation of the distance D between the object and the diffusing surface.

In one embodiment the device includes at least two detectors. One detector is preferably located close to the projector's scanning mirror and the other detector(s) is (are) displaced from the projector's scanning mirror. Preferably, the distance between the object and the screen is obtained by comparing the images generated by the two detectors. Preferably one detector is located within 10 mm of the projector and the other detector is located at least 30 mm away from the projector.

Preferably the detector(s) is (are) not a camera, is not a CCD array and has no lens. Preferably the detector is a single photosensor, not an array of photosensors. If two detectors are utilized, preferably both detectors are single photosensors, for example single photodiodes.

An additional embodiment of the disclosure relates a method of utilizing an interactive screen comprising the steps of:
a) projecting an interactive screen via a scanning projector;
b) placing an object into at least a portion of the area illuminated by the scanning projector;
c) synchronizing the motion of the projector's scanning mirror or the beginning an/or end of the line scans provided by the scanning projector with the input or signal acquired by at least one photo detector;
d) detecting an object by evaluating the width of its shadow with at least one photo detector; and
e) determining the location of the object with respect to at least a portion of said area as the object interacts with an interactive screen projected by the scanning projector.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic cross-sectional view of one embodiment;

FIG. 2 illustrates the evolution of the power of scattered radiation collected by the detector of FIG. 1 as a function of time, when the scanning projector of FIG. 1 is displaying a full white screen on a diffused surface.

FIG. 3A is an enlarged image of the center portion of a single frame shown in FIG. 2,

FIG. 3B illustrates schematically the direction of line scans across a diffusing surface as this surface is illuminated by the scanning mirror of the projector of FIG. 1;

FIG. 3C illustrates modulation of detected power vs. time, with the data including information about the object of FIG. 3B;

FIG. 4A illustrates a projected image with two synchronization features that are associated with the beginning of each line scan;

FIG. 4B illustrates pulses associated with the synchronization features of FIG. 4A;

FIG. 5 is an image that is detected by the device of FIG. 1 when a hand is introduced into the area illuminated by the scanning projector.

FIG. 6 illustrates schematically how an object introduced into the illuminated area shown in FIG. 1 produces two shadows;

FIG. 7A is an illustration of two detected images A and B of an elongated object situated over the diffused surface;

FIG. 7B is an illustration of a single detected image of an elongated object situated over the diffused surface;

FIG. 8 is a schematic illustration of the device and the illuminating object, showing how two shadows merge into a single shadow that produces the image of FIG. 7B;

FIG. 9A is a plot of the changes in detected position corresponding to the movement of a finger up and down by a few mm from the diffusing surface.

FIG. 9B illustrates schematically the position of a finger and its shadow relative to the orientation of line scans according to one embodiment;

FIG. 9C illustrates a projected image, synchronization features and a slider located on the bottom portion of the image;

FIG. 10A is a plot of the changes in detected width corresponding to the movement of along the diffusing surface;

FIG. 10B illustrates an image of a hand with an extended finger tilted at an angle α;

FIG. 11 illustrates schematically the device with two close objects situated in the field of illumination, causing the resulting shadows (images) of the two objects to overlap;

FIG. 12 illustrates schematically an embodiment of device that includes two spatially separated detectors;

FIG. 13A are images that are obtained from the embodiment of the device that utilizes two detectors;

FIGS. 13B and 13C illustrate schematically the position of a finger and its shadow relative to the orientation of line scans;

FIG. 14 is an image of fingers, where all of the fingers were resting on the diffused surface;

FIG. 15 is an image of fingers, when the middle finger was lifted up;

FIG. 16A is an image of an exemplary projected interactive keyboard;

FIG. 16B illustrates an exemplary modified keyboard projected on the diffusing surface;

FIG. 17A is an image of a hand obtained by a detector that collected only green light; and

FIG. 17B is an image of a hand obtained by a detector that collected only red light.

### DETAILED DESCRIPTION

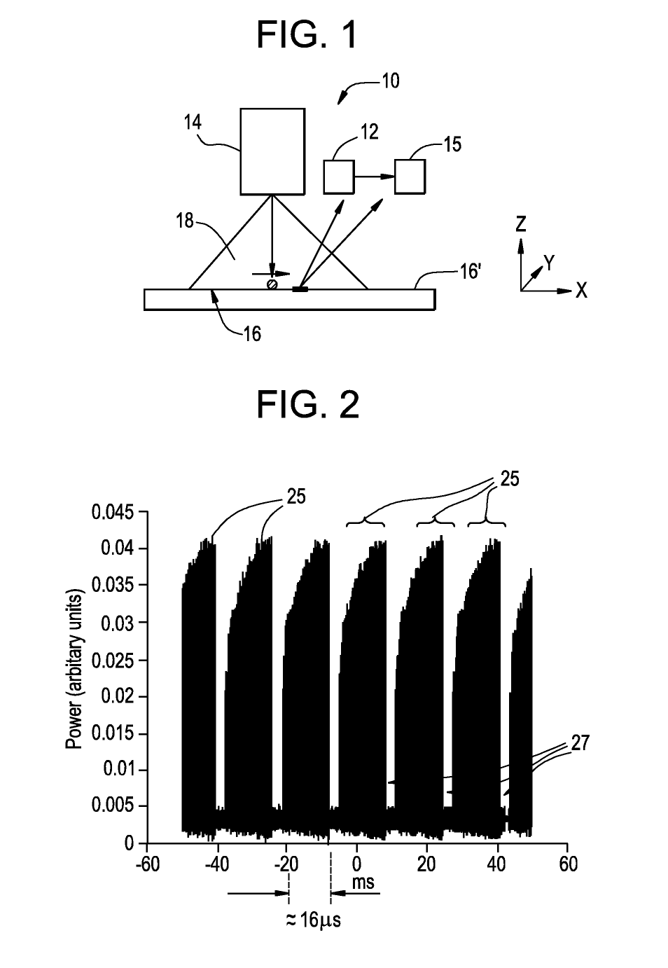

FIG. 1 is a schematic illustration of one embodiment of the device 10. In this embodiment the device 10 is a projector device with an interactive screen, which in this embodiment is a virtual touch screen for interactive screen applications. More specifically, FIG. 1 illustrates schematically how images can be created by using a single photo-detector 12 added to a laser scanning projector 14. The scanning projector 14 generates spots in 3 colors (Red, Green, Blue) that are scanned across a diffusing surface 16 such as the screen 16′ located at a certain distance from the projector 14 and illuminates the space (volume) 18 above or in front of the diffusing surface. The diffusing surface 16 such as the screen 16′ can act as the virtual touch screen when touched by an object 20, such as a pointer or a finger, for example. Preferably, the object 20 has different diffusing (light scattering) properties than the diffusing surface 16, in order for it to be easily differentiated from the screen 16. Thus, when the object 20, such as a pointer or a finger is located in the illuminated area, the light collected by the photo-detector 12 is changed, resulting in collected power different from that provided by the diffusing surface 16. The information collected and detected by the detector 12 is provided to the electronic device 15 for further processing.

In the embodiment of FIG. 1 the detector 12 is not a camera, is not a CCD array sensor/detector; and does not include one or more lenses. For example, a detector 12 may be a single photodiode, such as a PDA55 available from Thorlabs of Newton, N.J. The scanning projector 14 and the detector 12 are laterally separated, i.e., displaced with respect to each other, preferably by at least 20 mm, more preferably by at least 30 mm (e.g., 40 mm), such that the illumination angle from the projector is significantly different (preferably by at least 40 milliradians (mrad), more preferably by at least 60 mrad from the light collection angle of the detector 12. In this embodiment the displacement of the detector from the projector is along the X axis. In this embodiment the electronic device 15 is a computer that is equipped with a data acquisition board, or a circuit board. The electronic device 15 (e.g., computer) of at least this embodiment is capable of: (a) reconstructing, from the detector signal, at least a 2D image of the object and of the diffusing surface and (b) sensing the width W of the imaged object 20 (the width W of the imaged object in this embodiment includes the object's shadow) in order to determine the variation of the distance D between the object 20 and the diffusing surface 16. (At least in this embodiment the width is a measure in the direction of the line between the projector and detector, e. g., along the X axis). In this embodiment the electronic device 15 is capable of detecting the position in X-Y-Z of an elongated object, such as human finger, for example. The X-Y-Z position can then be utilized to provide interaction between the electronic device 15 (or another electronic device), and its user. Thus the user may perform use the finger movement to perform the function of computer mouse, to zoom on a portion of the displayed image, to perform 3D image manipulation of images, to do interactive gaming, to communicate between a blue tooth device and a computer, or to utilize the projected image as interactive screen.

Thus at least one embodiment the device 10 includes: (i) a laser scanning projector 14 for projecting light onto a diffusing surface 16 (e.g., screen 16′ illuminated by the projector); (ii) at least one detector 12 (each detector(s) is a single photodetector, not an array of photodetectors) that detects, as a function of time, the light scattered by the diffusing surface 16 and by at least one object 20 entering, or moving inside the space or volume 18 illuminated by the projector 14; and (iii) an electronic device 15 (e.g., computer) capable of (a) reconstructing, from the detector signal, an image of the object and of the diffusing surface and (b) determining the distance D between the object and the diffusing surface and/or the variation of the distance D between the object and the diffusing surface. FIG. 2 illustrates the evolution of the power of scattered radiation from the diffusing surface 16 collected by the detector 12 as a function of time, when the scanning projector displays a full white screen (i.e., the scanning projector 14 illuminates this surface, without projecting any images thereon). FIG. 2 shows of a succession of single frames 25 corresponding to relatively high detected power. Each frame corresponds to multiple line scans, and has duration of about 16 ms. The frames are separated by low power levels 27 corresponding to the projector fly back times during which the lasers are switched off to let the scanning mirror return to the start of image position.

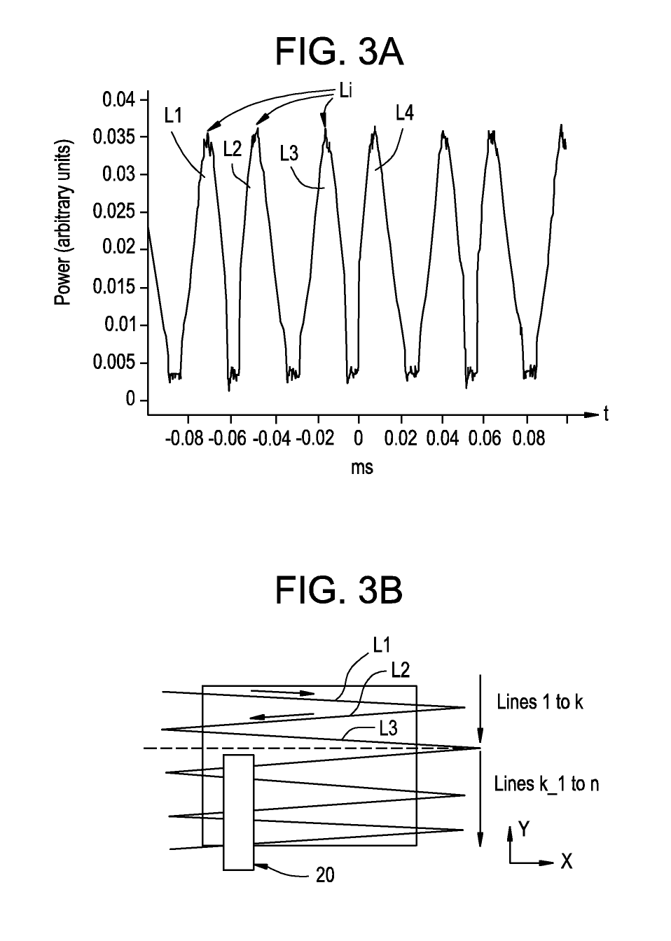

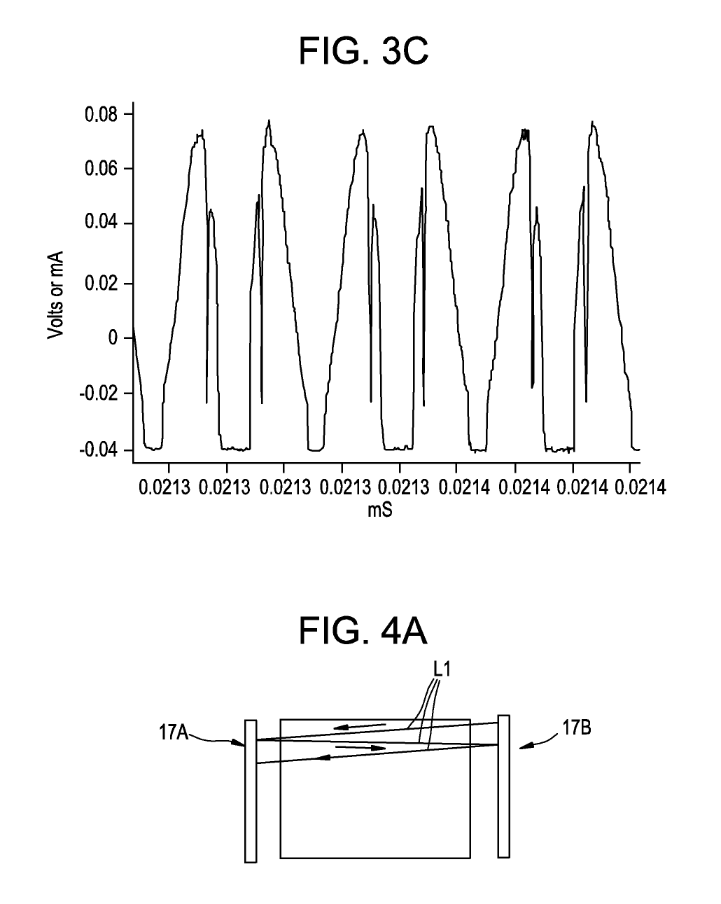

FIG. 3A is a zoomed view of the center of a single frame of FIG. 2, and shows that the detected signal consists of a succession of pulses, each corresponding to a single line Li of the image. More specifically, FIG. 3A illustrates modulation of the detected power vs. time (i.e., the modulation of the scattered or diffused light directed from the diffusing surface 16 and collected/detected by the detector 12). In order to illuminate the diffusing surface 16 the projector 14 utilizes a scanning mirror for scanning the laser beam(s) across the diffusing surface 16. The scanned lines Li (also referred to as line scans herein) are illustrated, schematically, in FIG. 3B. Thus, the modulation shown in FIG. 3A corresponds to individual line scans Li illuminating the diffused surface 16. That is, each of the up-down cycles of FIG. 3A corresponds to a single line scan Li illuminating the diffuse surface 16. The highest power (power peaks) shown in FIG. 3A correspond to the middle region of the line scans. As shown in FIG. 3B, the line scans Li alternate in direction. For example the laser beams are scanned left to right, then right to left, and then left to right. At the end of each scanned line, the lasers are usually switched OFF for a short period of time (this is referred to as end of line duration) to let the scanning mirror come back at the beginning of the next line.

Preferably, the projector (or the projector's a scanning mirror) and the detector are synchronized with respect to one another. By synchronizing the detected signal with the scanning projector (e.g., with motion of the scanning mirror, beginning of the scan), it is possible to transform the time dependent information into spatially dependent information (referred to as an image matrix herein) and re-construct a 2D or 3D image of the object 20 using an electronic device 15. Preferably, the scanning projector provides synchronization pulses to the electronic device at every new image frame and/or at any new scanned image line.

To illustrate how synchronization can be achieved, let us consider a simple example where the projector is displaying a white screen (i.e., an illuminated screen without image) and an elongated object 20 is introduced into the illuminated volume 18 as shown in FIG. 3B.

For the first lines (1 to k), the scanning beam is not interrupted by the object 20 and the signal collected by the photodiode is similar to the one shown in FIG. 3A. When an object, such as a hand, a pointer, or a finger enters the illuminated volume 18 and intercepts the scanning beam corresponding to scan lines k+1 to n, the scanning beam is interrupted by the object which results in a drop in optical power detected by the detector 12. (For example, in FIG. 3B, k=3.) This change is illustrated in FIG. 3C. More specifically, FIG. 3C, just like FIG. 3A, illustrates modulation in detected power vs. time, but the modulation is now due to the scattered or diffused light collected/detected by the detector 12 from both the object 20 and the diffusing surface 16. Thus, the patterns shown in FIGS. 3A and 3B differ from one another.

The device 10 transforms the time dependent information obtained from the detector to spatial information, creating an image matrix. For example, in order to create a 2D image of the object (also referred to as the image matrix herein), one method includes the steps of isolating or identifying each single line from the signal detected by the photodiode and building an image matrix where the first line corresponds to the first line in the photodetector signal, the second line corresponds to the second line in the photodetector signal, etc. In order to perform that mathematical operation, it is preferable to know at what time every single line started, which is the purpose of the synchronization.

In the embodiments where the detection system comprised of the detector and a computer that is physically connected to the projector, one approach to synchronization is for the projector to emit an electrical pulse at the beginning of each single line. Those pulses are then used to trigger the photodiode data acquisition corresponding to the beginning of each line. Since each set of acquired data is started at the beginning of a line, data is synchronized and one simply can take n lines to build the image matrix. For example, because the projector's scanning mirror is excited at its eigen frequency, the synchronization pulses can be emitted at the eigen frequency and is in phase with it.

The way that the image matrix is built needs to be taken into account. For example, lines Li are projected (scanned) left to right then right to left. (The direction of the line scans is illustrated, for example, in FIG. 3B.) Thus, the projector needs to provide information regarding whether each particular line is scanned left to right or right to left and the electronic device 15 associated with the light detection system when building the image matrix flips the image data corresponding to every other line depending on that information.

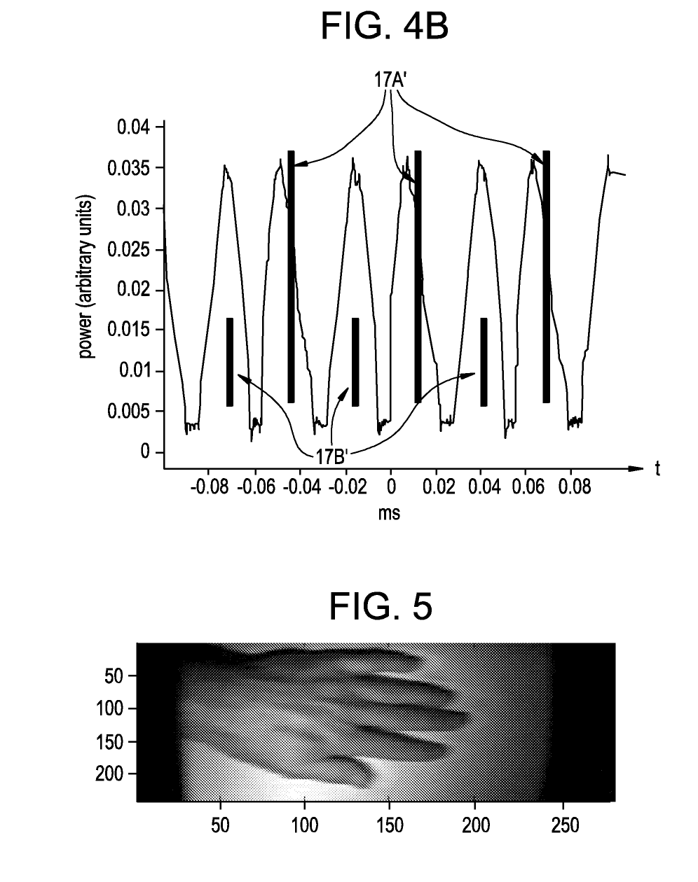

In some embodiments, the detection system is not physically connected to the projector or the projector is not equipped with the capability of generating synchronization pulses. The term “detection system” as used herein includes the detector(s) 12, the electronic device(s) 15 and the optional amplifiers and/or electronics associated with the detector and/or the electronic device 15. In these embodiments, it is possible to synchronize the detection of the image data provided by the detector with the position of the line scans associated with the image by introducing some pre-defined features that can be recognized by the detection system and used for synchronization purposes as well as discriminate between left-right lines and right-left lines. One possible solution is shown, as an example, in FIG. 4A. It includes adding synchronization features such as two vertical lines 17A and 17B to the projected image. In this embodiment, for example, the projected line on the left (line 17A) is brighter than the projected line on the right (line 17B). These lines 17A, 17B can be located either in the area that is normally used by the projector to display the images or it can be put in the region where the lasers are normally switched OFF (during the end of line duration) as illustrated in FIG. 4A. Thus, the signal detected by the photodetector includes a series of pulses 17A′, 17B′corresponding to lines 17A and 17B, and which can be used to determine the beginnings (and/or ends) of single lines Li. This is illustrated, for example, in FIG. 4B. Furthermore, because of the asymmetry of the illumination, one can determine the lines that are left-right (the brighter pulse is on the left) from the ones that are right-left (the brighter pulse is on the right).

FIG. 5 illustrates an image that is detected by the device 10 shown in FIG. 1 when as the projector 14 is projecting a full white screen and an object 20 (a hand) is introduced into the illuminated volume 18. When the photo-detector 12 detects light it produces an electrical signal that corresponds to detected light intensity. The system 10 that produced this image included a photo detector and a trans-impedance amplifier TIA that amplifies the electrical signal produced by the photodetector 12 and sends it to a data acquisition board of the computer 15 for further processing. In order to acquire the image of FIG. 5, in this embodiment the detector signal sampling frequency was 10 MHz and the detector and the amplifying electronics' (TIA's) rise time was about 0.5 microseconds. Preferably, the rise time is as short as possible in order to provide good resolution of the data generated by the detector 12, and thus good image resolution of the 2D image matrix. If we assume that the duration to write a single line is, for example, 30 microseconds and the rise time is on the order of 0.5 microseconds, the maximum image resolution in the direction of the image lines is about sample 60 points (e.g., 60 pixels on the re-generated image).

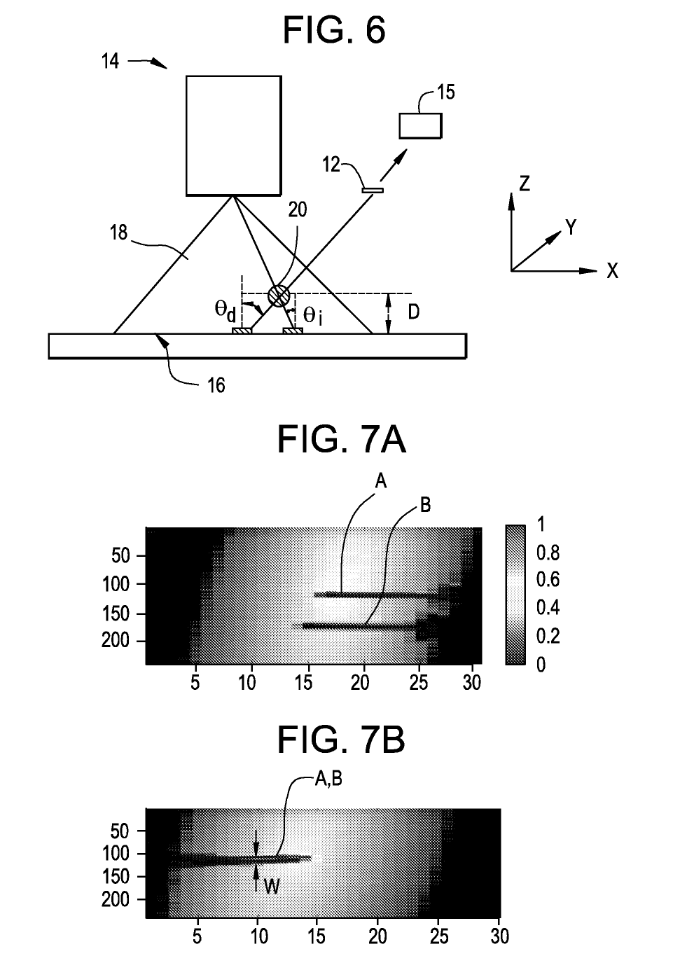

FIG. 6 illustrates schematically how to obtain 3-D information from the device 10 shown in FIG. 1. Let us consider the object 20 located in the illuminated volume 18 at a distance D away from the diffusing surface 16. It is noted that in this embodiment the object 20 has different light scattering characteristics from those of the diffusing surface 16. The diffusing surface 16 is illuminated by the projector 14 at illumination angle θᵢ and a detector 12 “sees” the object 20 at angle θ_{d}. When reconstructing the image, the expectation is that we should see two images: the first image (image A) is the image of the object itself, and the second image (image B) is the image of object's shadow (as shown in FIG. 7A), because the object 20 is obstructing the screen seen from the detector 12.

The separation Dx between the two images A and B is given by:

Dx=D (sin (θi)+sin (θd)), where D is the distance from the object to the diffusing surface 16.
Thus, D=Dx/(sin (θi)+sin (θd)).
Therefore, by knowing the two angles θi and θ_{d}, it is possible to measure the distance D.

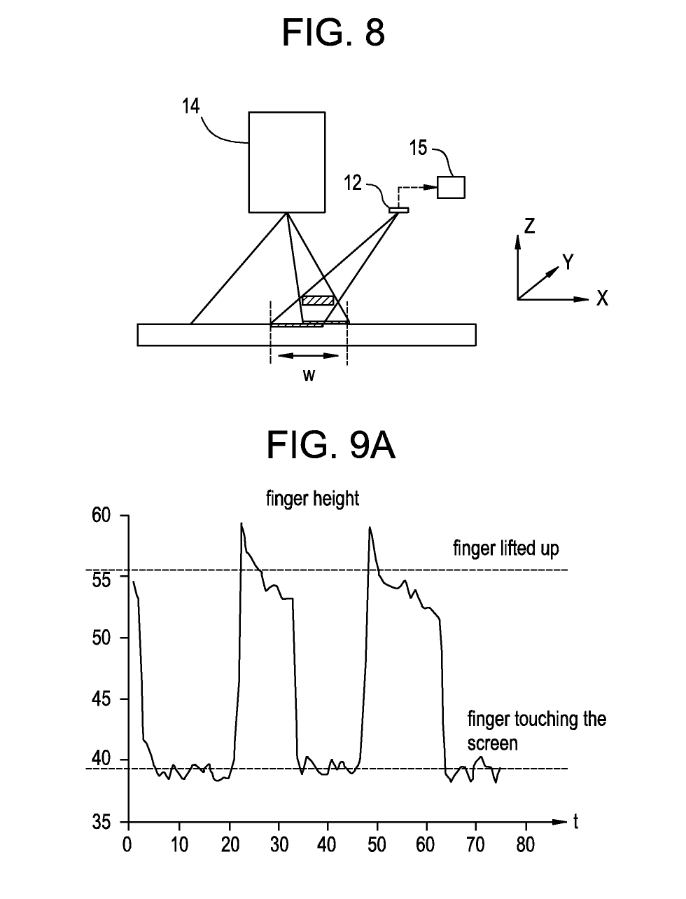

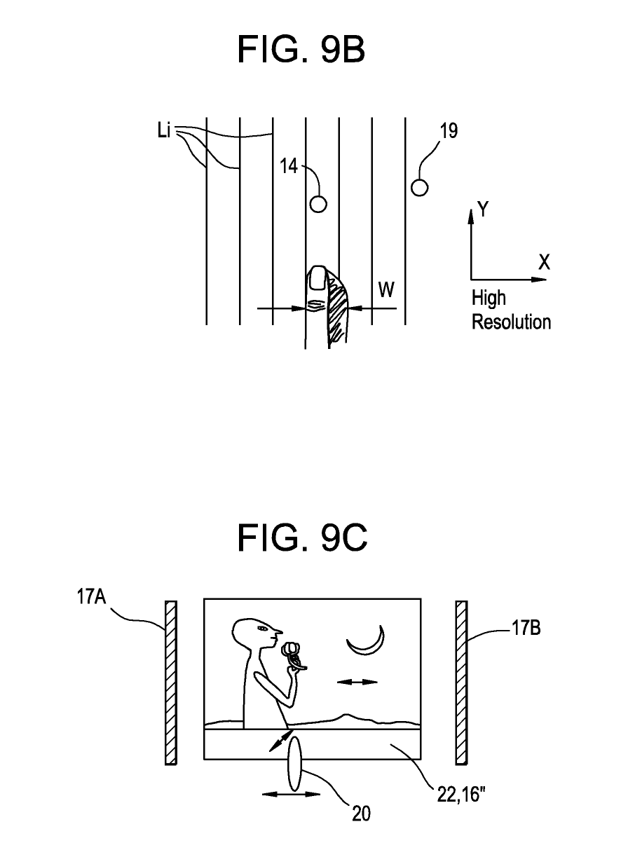

FIG. 7A illustrates that there are two images A and B of the object 20 (image A is the image of the object itself, and image B is the image of the object's shadow), such as a screw driver, when this object is placed in the illuminated volume 18, at a distance D from the screen 16′. FIG. 7B shows that when distance Dx was reduced, both images collapsed into a single image. The device 10 operating under this condition is illustrated schematically in FIG. 8. It is noted that the device 10 utilizes only one (i.e., single) detector 12, and when a relatively large object 20 such as a finger enters the illumination field (volume 18) and is only separated from the screen 16′ by a few millimeters, if the detector does not “see” two separated images A and B because they have merged into a single image as shown in FIG. 7B, it may be difficult to detect the vertical movement of the object by this method. Thus, in order to determine the distance D between the object and the screen 16′, instead of trying to detect two separated images of a given object, one can measure the width W of the detected object and track that width W as a function of time to have information on the variation of distance D between the object and the screen. In this embodiment, width W is the width of the object and its shadow, and the space therebetween (if any is present). (Note: This technique does not give an absolute value on the distance D, but only a relative value, because width W also depends on the width of the object itself). FIG. 9A illustrates the change in the detected width W when introducing an object 20 (a single finger) in the illuminated volume 18, and lifting the finger up and down by a few mm from the screen 16′. More specifically, FIG. 9A is a plot of the measured width W (vertical axis, in pixels) vs. time (horizontal axis). FIG. 9A illustrates how the width W of the image changes as the finger is moved up a distance D from the screen. For example, the width W increased to about 55 image pixels when the finger was raised away from the screen and decreased to about 40 image pixels when the finger was moved down to touch the screen 16′. FIG. 9A also illustrated that the finger stayed in touch with the screen 16′ for about 15 seconds before it was raised again. Thus, FIG. 9A illustrates that up and down movement of the finger can easily be detected with a device 10 that utilizes a single detector 12, by detecting transitions (and/or the dependence) of the detected width W on time. That is, FIG. 9A shows the variations of the detected finger width W (in image pixels). The finger was held the same lateral position, and was lifted up and down relative to the screen 16′.

As noted above, this technique does not give absolute information on the distance D since the width of the object is not known “a priority”. In order to obtain that information, one exemplary embodiment utilizes a calibration sequence every time a new object is used with the interactive screen. When that calibration mode is activated, the object 20 is moved up and down until it touches the screen. During the calibration sequence, the detection system keeps measuring the width of the object 20 as it moves up and down. The true width of the object is then determined as the minimum value measured during the entire sequence. Although this method of detection works well, it is may be limited to specific cases in terms of the orientation of the object with respect to the projector and detector positions. For example, when the projector 14 and the detector 12 are separated along the X-axis as shown in FIG. 1, this method works well if the object 20 is pointing within 45 degrees and preferably within 30 degrees from the Y axis, and works best if the object 20 (e.g., finger) is pointed along the Y-axis of FIGS. 1 and 8, as shown in FIG. 9B. Also, due to detection bandwidth limitation, the reconstituted images have lower resolution along the direction of the projector lines. Therefore, because in this embodiment the distance information is deduced from the shadow of the object, it is preferable that the shadow is created in the direction for which the reconstituted images have the highest resolution (so that the width W is measured highest resolution, which is along the X axis, as shown in FIG. 9B). Thus, a preferable configuration (for the device that utilizes one single detector) is one where the projected illumination lines (scan lines Li) are perpendicular to the detector's displacement. Thus, if the detector is displaced along the X direction, the direction of the elongated objects as well as the direction of the scanned lines provided by the projector should preferably be along Y axis.

In addition, the algorithm (whether implemented in software or hardware) that is used to determine the object position can also be affected by the image that is being displayed, which is not known “a priori”. As an example, if the object 20 is located in a very dark area of the projected image, the algorithm may fail to give the right information. The solution to this problem may be, for example, the use of a slider, or of a white rectangle, as discussed in detail below.

When the projected image includes an elongated feature (e.g., a picture of a hand or a finger), the projected feature may be mis-identified as the object 20, and therefore, may cause the algorithm to give an inappropriate result. The solution to this problem may also be, for example, the use of a slider 22, or of a white rectangle 22, shown in FIG. 9C, and as discussed in detail below. Since the slider is situated in a predetermined location, the movement of the finger on the slider can be easily detected.

That is, according to some embodiments, we can add to the projected image some portions that are homogeneously illuminated. In this embodiment, the algorithm analyzes the homogeneously illuminated portion of the image and detects only objects located there. Thus, in this embodiment the projected image also includes a homogeneously illuminated area 16″ or the slider 22, which is a small white rectangle or a square projected on the diffusing surface 16. There are no projected images such as hands or fingers within area 22. When an object enters the area 16″, or the slider 22, the program detects the object as well as its X and Y coordinates. That is, in this embodiment, the computer is programmed such that the detection system only detects the object 20 when it is located inside the homogeneously illuminated (white) area. Once the object 20 is detected, the detection system “knows” where the object is located. When the object moves with respect to the center of the white area in the X and/or in Y direction, the image of the object is modified, resulting in detection of its movement, and the homogeneously illuminated area 16″ is moved in such a way that it tracks continuously the position of the object 20.

This method can be used in applications such as virtual displays, or virtual keyboards, where the fingers move within the illuminated volume 18, pointing to different places on the display or the keyboard that is projected by the projector 14 onto the screen 16′. The detection of up and down movement of the fingers can be utilized to control zooming, as for example, when device 10 is used in a projecting system to view images, or for other control functions and the horizontal movement of the fingers may be utilized to select different images among a plurality of images presented side by side on the screen 16′.

Various embodiments will be further clarified by the following examples.

### Example 1

FIG. 1 illustrates schematically the embodiment corresponding to Example 1. In this exemplary embodiment the projector 14 and photo detector 12 are separated along the X-axis, the lines of the projector are along the Y-axis and the direction of the elongated objects (e.g., fingers) are along the same Y-axis. A typical image reconstituted from such conditions is shown on FIG. 5. In this exemplary embodiment the projector projects changing images, for example pictures or photographs. The projected image also include synchronization features, for example two bright lines 17A, 17B shown in FIG. 4A. For example, in a single detector system, the electronic device may be configured to include a detection algorithm that may include one or more of the following steps:
(i) Calibration step: When starting the application, the projector projects a full white image in addition to the synchronization features onto the diffusing surface 16. The image of the white screen (image I₀) is then acquired by the detector 12. That is, a calibration image I₀ corresponding to the white screen is detected and stored in computer memory. It is noted that the center of the projected image is likely to be brighter than the edges or the corners of the image.
(ii) Waiting phase: The projector projects arbitrary images such as pictures, in addition to projecting synchronization features (for example lines 17A and 17B) onto the diffusing surface 16. The algorithm monitors the intensity of the synchronization features and if their vary intensities significantly from the intensities of the synchronization features detected in the calibration image I₀, it means that an object has intersected the region where synchronization features are located. The algorithm then places the homogeneously illuminated area 16″ into the image (as shown, for example, in FIG. 9C). This area may be, for example, a white rectangle 22 situated at the bottom side of the image area. (This homogeneously illuminated area is referred to as a “slider” or slider area 22 herein). Thus, in this embodiment the user initiates the work of the interactive screen or keyboard by moving a hand, pointer or finger in the vicinity of synchronizing feature(s).

Alternatively, the projector 14 projects an image and the detection system (detector 12 in combination with the electronic device 15) is constantly monitoring the average image power to detect if an object such as a hand, a pointer, or a finger has entered the illuminated volume 18. Preferably, the electronic device 15 is configured to be capable of looking at the width of the imaged object to determine the distance D between the object and the diffusing surface, and/or the variation of the distance D between the object and the diffusing surface. When the object 20 enters the illuminated area, the average power of the detected scattered radiation changes, which “signals” to the electronic device 15 that a moving object has been detected. When an object is detected, the projector 14 projects or places a white area 22 at the edge of the image along the X-axis. That white area is a slider.
(iii) “Elimination of illumination irregularities ” step: When the projector creates a series of projected image(s) on the diffusing screen 16, the algorithm creates images Ii in real time, and divides them by the calibration images, creating a new image matrix I′₁, where I′₁=I₁/I₀ that corresponds to each projected image. This division eliminates irregularities in illumination provided by the projector.
(iv) “Slider mode”. The algorithm also detects any elongated object 20 entering the slider area 22, for example by using conventional techniques such as image binarization and contour detection. The distance D of the object 20 to the screen 16′ is also monitored by measuring the width W, as described above.
(v) Interaction with the screen. The elongated object, such as a finger may move laterally (e.g., left to right) or up and down relative to its initial position on or within area, as shown in FIG. 9C. In some embodiments, when the object 20, such as a finger, moves laterally and is touching the screen 16′ inside the slider area 22, the image (e.g., picture) moves in the direction of the sliding finger, leaving some room for a next image to appear. If the finger is lifted up from the screen, the image is modified by “zooming”around the center of the image.

For example, the algorithm may detect when a finger arrives in the white area 22 by calculating the image power along the slider area 22. The “touch” actions are detected by measuring the width W of the finger(s) in the slider image. For example, “move slider” actions are detected when the finger moves across the slider. When the “move slider” action is detected, a new series of pictures can then be displayed as the finger(s) moves left and right in the slider area.

Alternatively, the slider area 22 may contain the image of the keyboard and the movement of the fingers across the imaged keys provides the information regarding which key is about to be pressed, while the up and down movement of the finger(s) will correspond to the pressed key. Thus, the Example 1 embodiment can also function as a virtual keyboard, or can be used to implement a virtual keyboard. The keyboard may be, for example, a “typing keyboard” or can be virtual “plano keys” that enable one to play music.

Thus, in this embodiment, the detector and the electronic device are configured to be capable of: (i) reconstructing from the detector signal at least a 2D image of the object and of the diffusing surface; and (ii) sensing the width W of the imaged object to determine the distance D, and/or variation of the distance D between the object and the diffusing surface; (iii) and/or determining the position (e.g., XY position) of the object with respect to the diffusing surface.

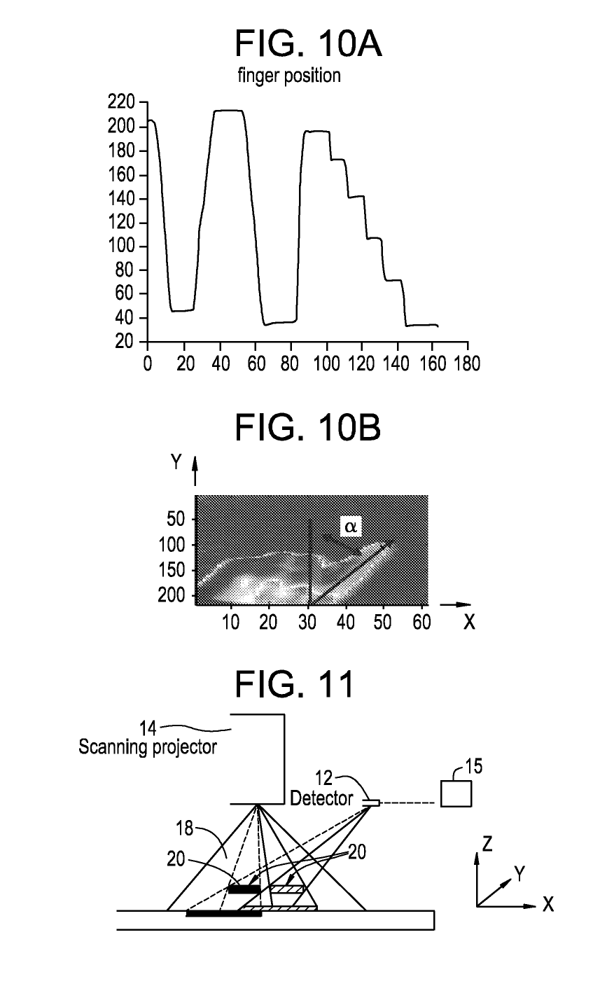

FIG. 10A shows the result of the algorithm (lateral position in image pixels) a finger position was detected as being up or down (the finger was moved along the slider area 22 in the X-direction.) as a function of time. More specifically, FIG. 10A illustrates that the finger's starting position was on the left side of the slider area 22 (about 205 image pixels from the slider's center). The finger was then moved to the right (continuous motion in X direction) until it was about 40 image pixels from the slider's center and the finger stayed in that position for about 8 sec. It was then moved to the left again in a continuous motion until it arrived at a position at about 210 pixels from the slider's center. The finger then moved from that position (continuous motion in X direction) to the right until it reached a position located about 25-30 pixels from the slider's center, rested at that position for about 20 sec and then moved to the left again, to a position about 195 pixels to the left of the slider's center. The finger then moved to the right, in small increments, as illustrated by a step-like downward curve on the right side of FIG. 10A.

In addition to the finger's position, the angle of an object (such as a finger) with respect to the projected image can also be determined For example, the angle of a finger may be determined by detecting the edge position of the finger on or over a scan-line, by scan-line basis. An algorithm can then calculate the edge function Y(X) associated with the finger, where Y and X are coordinates of a projected image. The finger's angle α is then calculated as the average slope of the function Y(X). FIG. 10B illustrates an image of a hand with an extended finger tilted at an angle α. The information about the angle α can then be utilized, for instance, to rotate a projected image, such as a photograph by a corresponding angle.

Below is a description of an exemplary algorithm that can be utilized for image manipulation of projected images. This algorithm utilizes 2D or 3D information on finger location.

Algorithm utilizing detection of images of finger(s):
(I) If there is no finger detected in the projected image field—Wait;
(II) If there is only one finger detected in the projected image field and;
   (a) If finger is not touching the screen—Wait;
   (b) If finger is touching the screen and is moving in X/Y—Translate image according to finger translation;
   (c) If finger is touching the screen and is NOT moving in X/Y—Rotate in the image plane image based on finger rotation angle, α;
(III) If two fingers are detected in the projected image field,
   (a) If finger 1 is touching the screen and finger 2 is not touching the screen—Zoom in the image by an amplitude proportional to finger 2 height
   (b) If finger 1 is not touching the screen and finger 2 is touching the screen—Zoom out the image by an amplitude proportional to finger 1 height; and
(IV) If none of the two fingers are touching—Perform image 3D rotation with an amplitude proportional to the difference in height between both fingers.

Thus, according to at least one embodiment, a method of utilizing an interactive screen includes the steps of:
a) projecting an image or an interactive screen on the interactive screen;
b) placing an object in proximity of the interactive screen;
c) forming an image of the object and obtaining information about object's location from the image;
d) utilizing said information to trigger an action by an electronic device.

For example, the object may be one or more fingers, and the triggered/performed action can be: (i) an action of zooming in or zooming out of at least a portion of the projected image; and/or (ii) rotation of at least a portion of the projected image. For example, the method may further include the step(s) of monitoring and/or determining the height of two fingers relative to said interactive screen (i.e., the distance D between the finger(s) and the screen), and utilizing the height difference between the two fingers to trigger/perform image rotation. Alternatively, the height of at least one finger relative to the interactive screen may be determined and/or monitored, to so that the amount of zooming performed is proportional to the finger's height (e.g., more zooming for larger D values).

In some exemplary embodiments, an algorithm detects which finger is touching the screen and triggers a different action associated with each finger (e.g., zooming, rotation, motion to the right or left, up or down, display of a particular set of letters or symbols).

Multiple shadows can make the image confusing when multiple objects (for example, multiple fingers) are in the field of illumination (volume 18). FIG. 11 illustrates schematically what happens when two or more closely spaced objects are introduced into the field of illumination. Due to the multiple shadow images, the images of the two or more objects are interpenetrating, which makes it difficult to resolve the objects. This problem may be avoided in a virtual key board application, for example, by spacing keys an adequate distance from one another, so that the user's fingers stay separated from one another during “typing”. For example, in virtual “typing” keyboard applications, the projected keys are preferably separated by about 5 mm to 15 mm from one another. This can be achieved, for example, by projecting an expanded image of the keyboard over the illuminated area.

### Example 2

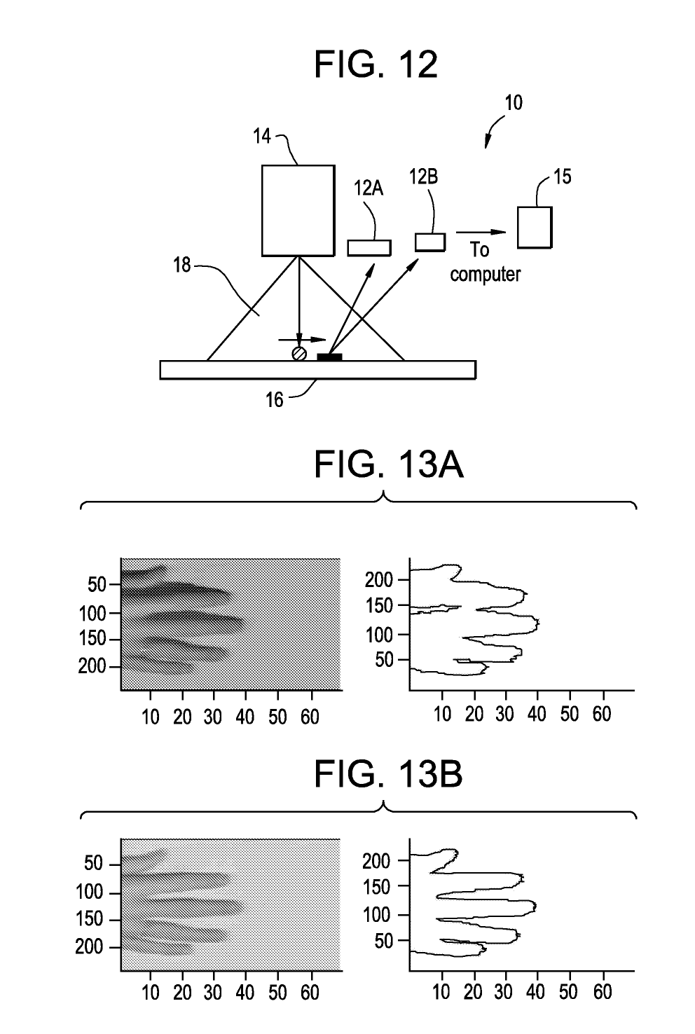

As described above, device 10 that utilizes a single off-axis detector, and the process utilizing width detection approach works well, but may be best suited for detection of a single object, such as a pointer. As described above, multiple shadows can make the image confusing when multiple objects are situated in the field of illumination in a way that multiple shadow images seen by the single of-axis detector are overlapping or in contact with one another. (See, for example the top left portion of FIG. 13A.) In order to solve the resolution problem of closely spaced objects, the Example 2 embodiment utilizes two spaced detectors 12A, 12B to create two different images. This is illustrated, schematically, in FIG. 12. The distance between the two detectors may be, for example, 20 mm or more. The first detector 12A is placed as close as possible to the projector emission point so that only the direct object shadow is detected by this detector, thus avoiding interpenetration of images and giving accurate 2D information (see bottom left portion of FIG. 13A). The second detector 12B is placed off axis (e.g., a distance X away from the first detector) and “sees” a different image from the one “seen” by the detector 12A (See the top left portion of FIG. 13B). For example, the first detector 12A may be located within 10 mm of the projector, and the second detector 12B may be located at least 30 mm away from the first detector 12A. In the FIG. 12 embodiment, the 3D information about the object(s) is obtained by the computer 15, or a similar device, by analyzing the difference in images obtained respectively with the on-axis detector 12A and the off-axis detector 12B. More specifically, the 3D information may be determined by comparing the shadow of the object detected by a detector (12A) that is situated close to the projector with the shadow of the object detected by a detector that is situated further away from the projector (12B).

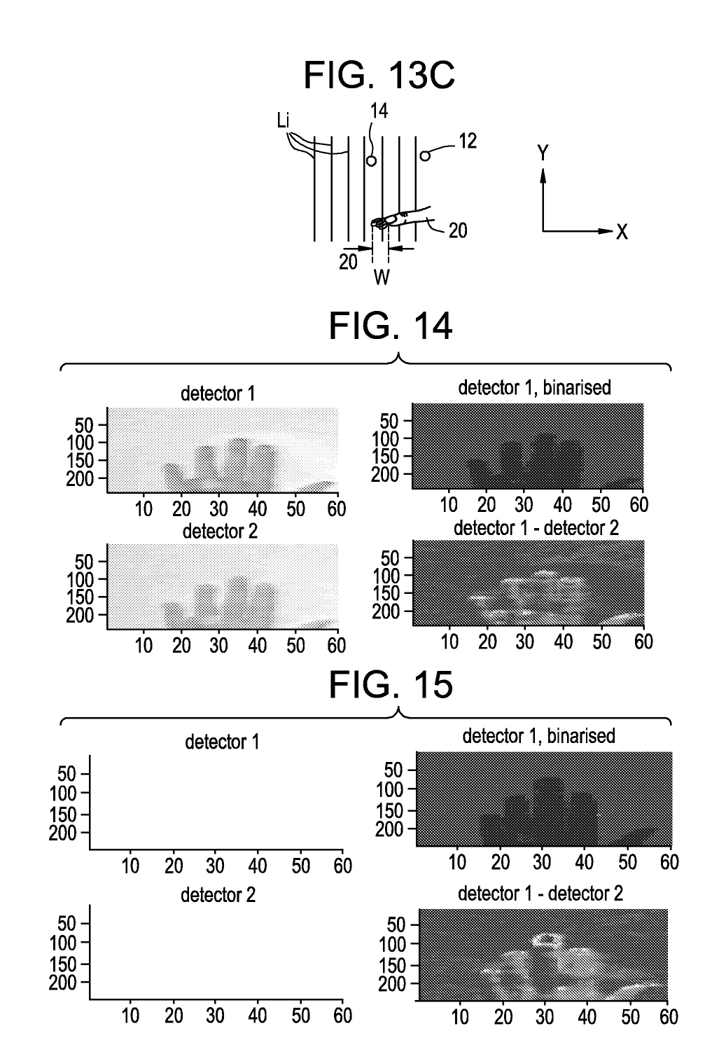

When two detectors are used, the ideal configuration is to displace the detectors in one direction (e.g., along the X axis), have the elongated object 20 (e.g., fingers) pointing mostly along the same axis (X axis) and have the projector lines Li along the other axis (Y), as shown in FIGS. 12, 13B and 13C. The images obtained from the two detectors (see FIG. 14, top and bottom) can be compared (e.g., subtracted from one another, to yield better image information. In the embodiment(s) shown in FIGS. 12, 13B and 13C, the scanning projector 14 has a slow scanning axis and a fast scanning axis, and the two detectors are positioned such that the line along which they are located is not along the fast axis direction and is preferably along the slow axis direction. In this embodiment it is preferable that the length of the elongated object is primarily oriented along the fast axis direction (e.g., within 30 degrees of the fast axis direction).

### Example 3

FIG. 14 illustrates images acquired in such conditions. More specifically, the top left side of FIG. 14 is the image obtained from the off-axis detector 12B. The top right side of FIG. 14 depicts same image, but the image is binarized. The bottom left side of FIG. 14 is the image obtained from the on-axis detector 12A. The bottom right side of FIG. 14 is an image in false color calculated as the difference of the image obtained by the on-axis detector and the off-axis detector.

In FIG. 14, all of the fingers were touching the diffusing surface (screen 16′). In FIG. 15 the image was acquired when the middle finger was lifted up. The top left portion of FIG. 15 depicts a dark area adjacent to the middle finger. This is the shadow created by the lifted finger. The size of the shadow W indicates how far the end of the finger has been lifted from the screen (the distance D). As can be seen on the bottom right image, the blue area at the edge of the finger has grown considerably (when compared to that on the bottom right side of FIG. 14), which is due to a longer shadow seen by the off-axis detector 12B. The bottom right side of FIG. 15 is a false color image obtained by subtracting from the normalized image provided by the on-axis detector the normalized image obtained from the off-axis detector. (Dark blue areas (see the circled area) correspond to negative numbers.) In one exemplary embodiment that utilizes two spatially separated photo detectors in its detection system, the algorithm for detecting moving objects (i.e., the “touch” and position detection algorithm) includes the following steps:
a) Calibration step: Acquiring calibration images I₀₁ and I₀₂ when the projector 14 is projecting a full white screen onto the diffusing surface 16. The calibration image I₀₁ corresponds to the image acquired by the on-axis detector 12A and the calibration image I₀₂ corresponds to the image acquired by the of-axis detector 12B. That is, calibration images I₀₁ and I₀₂ correspond to the white screen seen by the two detectors. These calibration images are can then be stored in computer memory, after acquisition.
b) Making real-time acquisition of images I₁ and I₂. When the projector 14 creates a series of projected images on the diffusing screen 16, the algorithm creates a series of pairs of images I₁, I₂ (images I₁, I₂ correspond to the image acquired in real-time, the images I₁, are acquired by the on-axis detector 12A and the image I₂ corresponds the image acquired by the off-axis detector 12B).
c) Calculating images A₁, A₂ and B. After creation of the images I₁, I₂ the algorithm then normalizes them by dividing them by the calibration images, creating new image matrices A1, and A2, where Aᵢ=Iᵢ/I₀ᵢ that corresponds to each projected image. This division eliminates irregularities in illumination. Thus, A₁=I_{I}/I₀₁ and A₂=I₂/I₀₂, where dividing, as used herein, means that the corresponding single elements of the two image matrices are divided one by the other. That is, every element in the matrix Iᵢ is divided by the corresponding element of the calibration matrix I₀₁. Image B is then calculated by comparing the two images (image matrices) A₁ and A₂. This can be done, for example, by subtracting image matrix obtained from one detector from the image matrix obtained by the other detector. In this embodiment, B=A₂−A₁.
d) From on-axis image A₁ (i.e. the image corresponding to the on-axis detector), obtain the lateral position of the fingers by using conventional methods such as binarization and contour detection.
e) Once the object, has been detected, define a window around the end of object (e.g., a finger). Count how many pixels (P) in the window of matrix B are below a certain threshold. The distance between the object (such as a finger) and the screen is then proportional to that number (P). In the exemplary embodiment that we utilized in our lab, the finger was considered as touching the screen if less than 8 pixels were below a threshold of −0.7. Although those numbers seemed to work with most fingers, some re-calibration may sometimes be needed to deal with special cases such as fingers with nail polish, for example).

Accordingly, a method for detecting moving object(s) includes the steps of:
a) Placing an object into at least a portion of the area illuminated by a scanning projector;
b) Synchronizing the motion of the projector's scanning mirror or the beginning and/or end of the line scans provided by the scanning projector with the input acquired by at least one photo detector;
c) Detecting an object with at least one photo detector; and
e) Determining the location of the object with respect to at least a portion of the area illuminated by a scanning projector.

According to one embodiment the method includes the steps of:
a) Projecting an interactive screen or an image via a scanning projector;
b) Placing an object in at least a portion of the area illuminated by a scanning projector;
c) Synchronizing the motion of the projector's scanning mirror with the detection system to transform the time dependent signal obtained by at least one detector into at least a 2D image of an object; and
d) Detecting the distance D of the object from the screen 16, or the variation in distance D, by analyzing the shape or size or width W of the object's shadow;
e) Determining the location of the object with respect to at least a portion of said area as the object interacts with an interactive screen or the image projected by the scanning projector.

According to some embodiments, the images of the object are acquired by at least two spatially separated detectors, and are compared with one another in order to obtain detailed information about object's position. Preferably the two detectors are separated by at least 20 mm.

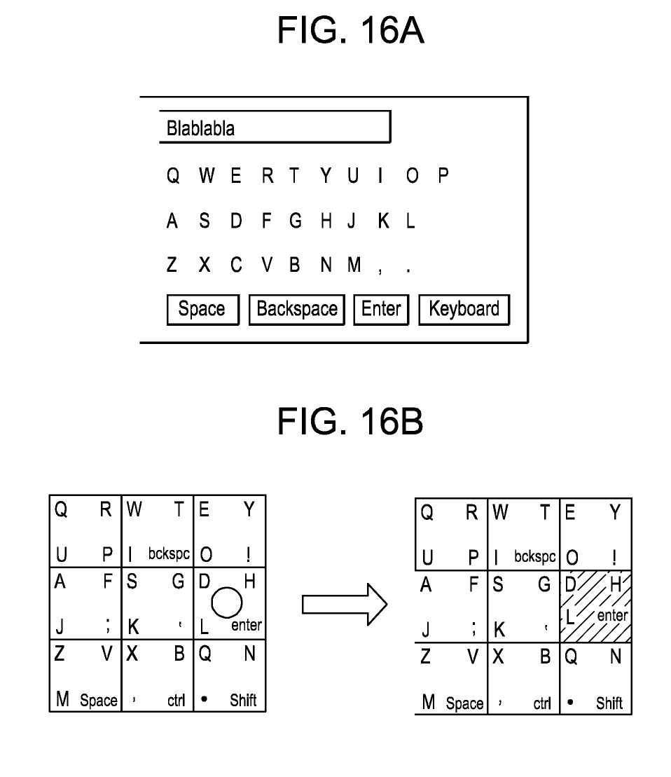

FIG. 16 shows an example of an application that utilizes this algorithm. The projector 14 projects an image of a keyboard with the letters at pre-determined location(s). The position of the object 20 (fingers) is monitored and the algorithm also detects when a finger is touching the screen. Knowing where the letters are located, the algorithm finds the letter closest to where a finger has touched the screen and adds that letter to a file in order to create words which are projected on the top side of the keyboard image. Every time a key is pressed, the electronic device emits a sound to give some feedback to the user. Also, to avoid pressing a key twice by mistake, because the finger touched the screen for too long, the algorithm checks that, when a “ touch ” is detected for a given finger, that finger was not already touching the screen in the previous image.

Some additional features might also be incorporated in the algorithm in order to give to the user more feedback. As an example, when multiple fingers are used, the sound can be made different for each finger.

The projected image shown in FIG. 16A may include a special key (“keyboard”) When pressing that key, the projector projects a series of choices of different keyboards or formatting choices (e.g., AZERTY, QWERTY, uppercase, undercase, font, numeric pad, or other languages). The program will then modify the type of the projected keypad according to the user selection, or select the type of the projected keypad according to the user's indication.

In addition, finger image information can be utilized to perform more elaborate functions. As an example, the algorithm can monitor the shadows located at the ends of multiple fingers instead of one single finger as shown on FIG. 14. By monitoring multiple fingers' positions, the algorithm can determine which finger hit the screen at which location and associate different functions to different fingers. FIG. 16B shows, for example, a modified keyboard projected onto the diffuse surface. The image is made of multiple separated areas, each of them containing 4 different characters. When a finger is touching one of those areas, the algorithm determines which finger made it and chooses which letter to select based on which finger touched that area. As illustrated on FIG. 16B, when the second finger touched, for instance, the second top area, the letter “T” will be selected since it is the second letter inside that area. In some exemplary embodiments, an algorithm detects which finger is touching the screen and triggers a different action associated with each finger or a specific action associated with that finger(e.g., zooming, rotation, motion to the right or left, up or down, display of a particular set of letters or symbols).

Optimization of the image quality can be done by compensating for uneven room illumination (for example, by eliminating data due to uneven room illumination) and by improving image contrast. The power collected by the detector(s) is the sum of the light emitted by the scanning projector and the light from the room illumination. As a consequence, when the room illumination is varying, image parameters such as contrast or total image power are affected, and may result in errors when processing the image.

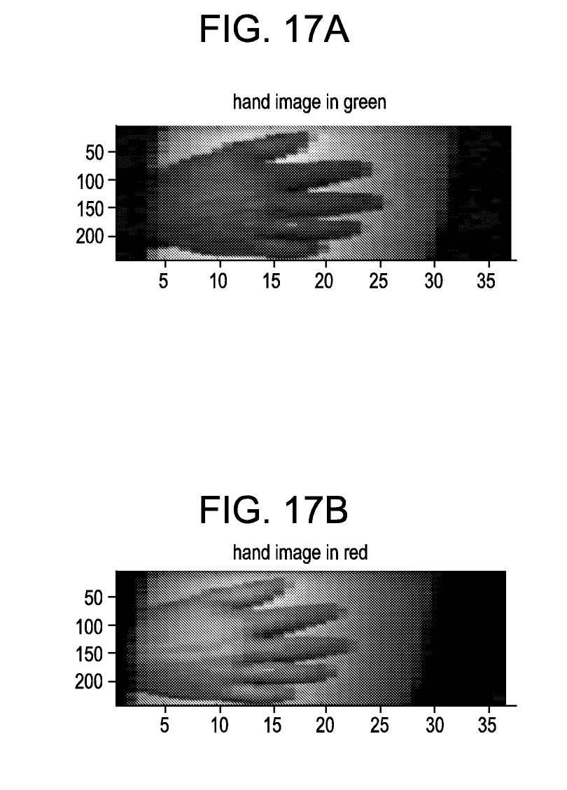

In order to eliminate the contribution of room illumination to the image, the algorithm can analyze the received signals when the lasers are switched off, for instance during the fly-back times. The average power over those periods is then subtracted from the signal during the times when the lasers are turned on. In order to obtain the optimum image quality, it is important to optimize the contrast, which is a function of the difference between the screen's diffusion coefficient and the object's diffusion coefficient. FIGS. 17A and 17B are images of a hand obtained when collecting only green light or only red light. As can be seen, the contrast of the hand illuminated with green light (FIG. 17A) is significantly batter than the image illuminated by the red light (FIG. 17B) which is due to the fact that the absorption coefficient of skin is higher when it is illuminated by green light instead of in red light

Thus, by inserting a green filter in front of the detector(s), the contrast of the images can be improved. The use of green filter presents some advantages for image content correction algorithms, because only one color needs to be taken into consideration in the algorithm. Also, by putting a narrow spectral filter centered over the wavelength of the green laser, most of the ambient room light can be filtered out by the detection system.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A virtual interactive screen device comprising:
(i) a laser scanning projector that projects light onto a diffusing surface illuminated by the laser scanning scanning projector, said laser projector including at least one scanning mirror;
(ii) at least one no detector that detects, as a function of time, the light scattered by the diffusing surface and by at least one object entering the area illuminated by the scanning projector, wherein said detector and projector are synchronized; and
(iii) an electronic device capable of (a) reconstructing, from the detector signal, an image of the object and of the diffusing surface and (b) determining the location of the object relative to the diffusing surface.

2. The device of claim 1 wherein said projector generates synchronization information provided to said electronic device, and said electronic device is configured to transform time dependent signal information received from said detector into an image matrix

3. The device of claim 1 wherein the electronic device is capable of using the width of the imaged object to the determine the distance D between the object and the diffusing surface, and/or the variation of the distance D between the object and the diffusing surface.

4. The device of claim 3, wherein the scanning projector and the a least one detector are displaced with respect to one another in such a way that the illumination angle from the projector is different from the light collection angle of the at least one detector; and the electronic device is configured to:
(i) reconstruct from the detector signal at least a 2D image of the object and of the diffusing surface; and (ii) utilize the width W of the imaged object and/or its shadow to determine the distance D and/or variation of the distance D between the object and the diffusing surface.

5. The device of claim 1 wherein said device has only one detector and said detector is is not an arraed detector.

6. The device of claim 1 wherein said device has two detectors and said detectors are not an arraed detectors.

7. The virtual touch screen device of claim 2, wherein said object is an elongated object, and said electronic device is capable of detecting the position in X-Y-Z of at least a portion of the elongated objects.

8. The device of claim 7, wherein said the X-Y-Z position is utilized to provide interaction between said device and its user.

9. The device of claim 2, wherein said device includes an algorithm such that when the detected width rapidly decreases two times within a given interval of time, and reaches twice the same low level, the device responds to this action as a double click on a mouse.

10. The device of claim 2, wherein said device includes a single photodetector said single photodetector is a photodiode, and is not a CCD array, and is not a lensed camera.

11. The device of claim 10, wherein said single d single photodiode conjunction with said scanner creates or re-creates 2D and/or 3D images.

12. The device of claim 2, wherein said device includes at least two detectors spatially separated from one another.

13. The device of claim 12, wherein one of said two detectors is situated close to the projector, and the other detector is located further away from the projector.

14. The device of claim 13, wherein the photodetector situated close to the projector provides 2D (X, Y) image information, and the second detector in conjunction with the first photodiode provides 3D (X, Y, Z) image information.

15. The device of claim 13, wherein said electronic device determines distances between the object and the diffusing surface by comparing the two images obtained with the two detectors.

16. The device of claim 13, wherein laser scanning projector that projects images on a diffusing surface has a slow scanning axis and a fast scanning axis, and said at least two detectors are positioned such that the line along which they are located is not along the slow axis direction.

17. The device of claim 13, wherein the length of the elongated object is primarily along the fast axis direction.

18. The device of claim 14 where 3D information is determined by comparing the shadow of the object detected by detector that is situated close to the projector with the shadow of the object detected by detector that is situated further away from the projector.

19. The device of claim 1 where the scanning projector provides synchronization pulses to the electronic device at every new image frame or at any new image line.

20. The device of claim 19 where the projector's scanning mirror is excited at its eigen frequency and the synchronization pulses are emitted at that eigen frequency and is in phase with it.

21. The virtual touch screen device of claim 1, wherein a green filter is situated in front of said detector.

22. A method of utilizing an interactive screen comprising the steps of:
a) projecting an image or an interactive screen via a scanning projector;
b) placing an object in at least a portion of the area illuminated by a scanning projector;
c) synchronizing the motion of the projector's scanning mirror at the beginning or the end of the line scans provided by the scanning projector with the input acquired by at least one photo detector;
d) detecting an object by evaluating the width of its shadow with at least one photo detector; and
e) determining the location of the object with respect to at least a portion of said area as the object interacts with an interactive screen projected by the scanning projector.

23. A method of utilizing an interactive screen comprising the steps of:
a) projecting an image or an interactive screen on the interactive screen;
b) placing an object in proximity of the interactive screen;
c) forming an image of the object and obtaining information about object's location from said image;
d) utilizing said information to trigger an action by an electronic device.

24. The method of utilizing an interactive screen of claim 22, wherein said object is at least one finger and said action is (i) an action of zooming in or zooming out of at least a portion of the projected image; and/or (ii) rotation of at least a portion of the projected image.

25. The method of claim 24 further including the step of monitoring the height of two fingers relative to said interactive screen, and utilizing the height difference between the two fingers to perform said rotation.

26. The method of claim 24 further including the step of the height of at least one finger relative to the interactive screen, wherein the amount of zoom is proportional to the finger's height.

27. The method of claim 24 an algorithm detects which finger is touching the screen and triggers a different action associated with each finger

28. The virtual touch screen device comprising:
(i) an interactive screen capable of forming at least one image of a moving object;
(ii) a processor capable of analyzing data provided by the at least one image of the moving object, said data including information related to the distance from the object to the interactive screen.

29. The virtual touch screen device of claim 28, wherein the at least one image of the moving object is a 2-dimensional image.

30. The virtual touch screen device of claim 28, wherein the at least one image of the moving object is a 3-dimensional image.
